(19) United States
(12) Patent Application Publication
(10) Pub. No.: US 2013/0110720 A1
(43) Pub. Date: May 2, 2013

(54) SYSTEM AND METHOD FOR UTILIZING STUDENT ACCOUNTS

(71) Applicants: Gaurav Rekhi, San Jose, CA (US); Donald James Perciful, San Jose, CA (US); Scott Robert Shipman, San Jose, CA (US)

(72) Inventors: Gaurav Rekhi, San Jose, CA (US); Donald James Perciful, San Jose, CA (US); Scott Robert Shipman, San Jose, CA (US)

(21) Appl. No.: 13/543,073

(22) Filed: Jul. 6, 2012

Related U.S. Application Data
(63) Continuation of application No. 13/286,938, filed on Nov. 1, 2011.

(51) Int. Cl. G06Q 40/02; G06Q 20/40

(52) U.S. Cl. 705/44; 705/35

(57) ABSTRACT

A system and method for creating an account for a minor in a networked environment is provided. In example embodiments, instructions to establish the account for a minor from a verified adult that is verified as an adult based on financial information associated with an adult account established for the verified adult is received. The account for the minor that is linked to the adult account of the verified adult is created. A secondary payment account is linked to the account of the minor. The secondary payment account is a payment account established for the minor that is financially linked to an adult payment account of the verified adult.

### CLAIM OF PRIORITY

This application is a continuation of U.S. application Ser. No. 13/286,938 filed Nov. 1, 2011, which application is incorporated in its entirety heroin by reference.

### FIELD

The present disclosure relates generally to network transactions, and in a specific example embodiment, to utilizing student accounts in a networked environment.

### BACKGROUND

Conventionally, it is difficult for minors (e.g., any individual under the age of 18) to transact in a networked environment (e.g., online or mobile). Due to legal regulations, a minor is required to obtain parental consent to create the accounts. In some cases, the minor may borrow their parent's credit card or use the parent's information and account to conduct transactions. These transactions may include, for example, buying or selling items, accessing information, and posting information in the networked environment. In other cases, the minor may provide false information (e.g., providing contact information to a friend who pretends to be the parent) in order to obtain a false consent for the creation of the account or to perform other transactions in the networked environment.

### BRIEF DESCRIPTION OF DRAWINGS

Various ones of the appended drawings merely illustrate example embodiments of the present invention and cannot be considered as limiting its scope.

FIG. 1 is a block diagram illustrating an example embodiment of a network architecture of a system used to determining query aspects.

FIG. 2 is a block diagram illustrating an example embodiment of a publication system.

FIG. 3 is a block diagram illustrating an example embodiment of a student account engine.

FIG. 4 is a flow diagram of an example high-level method for establishing a student account.

FIG. 5 is a flow diagram of an example high-level method for verifying consent for creating an external account.

FIG. 6 is a flow diagram of an example method for processing a transaction and checking constraints of a student account.

FIG. 7a is sample user interface for creating a student account,

FIG. 7b is a sample user interlace for establishing constraints for the networked system for the student account.

FIG. 7c is a sample user interface for establishing consent and constraints for external sites for the student account.

FIG. 8 is a simplified block diagram of a machine in an example form of a computing system within which a set of instructions for causing the machine to perform any one or more of the methodologies discussed herein may be executed.

### DETAILED DESCRIPTION

The description that follows includes systems, methods, techniques, instruction sequences, and computing machine program products that embody illustrative embodiments of the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

As used herein, the term “or” may be construed in either an inclusive or exclusive sense. Additionally, although various example embodiments discussed below focus on a marketplace environment, the embodiments are given merely for clarity in disclosure. Thus, any type of electronic publication, electronic commerce, social networking, or electronic business system and method, including various system architectures, may employ various embodiments of the content system and method described herein and may be considered as being within a scope of example embodiments. Each of a variety of example embodiments is discussed in detail below.

Example embodiments described herein provide systems and methods for utilizing student accounts. The student accounts provide a consent-based solution where minors can have their own accounts on a networking environment, but their parents or legal guardians (collectively referred to as “adult” or “adults”) are held accountable for the minor's actions. Using the student account, the minor may conduct transactions in the networking environment, while the adult can elect to have full visibility, has the ability to approve/deny transactions, can grant permission to businesses to collect minor's personal information, and can grant rights to the minor.

In various example embodiments, a system and method for utilizing a student account in a networked environment is provided. In example embodiments, instructions to establish a student account for a minor from a verified adult that is verified as an adult based on financial information associated with an adult account established for the verified adult is received. The instructions include information for establishing the student account. A legal relationship between the verified adult and the minor for which the student account is being established is verified. Based on the relationship being verified, the student account for the minor that is linked to the adult account is created.

The adult may establish constraint settings for transactions that the minor performs using their student account. The constraints may include, for example, approving transactions, monitoring transactions, monitoring communications, approving communications, setting monetary limits, restricting categories, restricting items, restricting merchants, approving addition of new connections, or monitoring addition of new connections.

The adult may also establish consent settings for the student account that indicate at least one particular website or entity (e.g., business or legal entity) at which the minor is allowed to create an account. The particular website may include, for example, a social network site, a shopping site, a marketplace, or a community of which the minor is a member.

Subsequent transactions may be checked against these consent settings and constraint settings established for the student account. By using embodiments of the present invention, transactions initiated by a minor may be quickly and easily verified for parental consent. For example, instead of an external site having to manage a process of contacting every adult in an attempt to verify consent from a parent for creating an account, purchasing an item, or performing other forms of transactions, a pre-established list of consent and constraints from a single source may be accessed and reviewed. Accordingly, one or more of the methodologies discussed herein may obviate a need for constant communication with adults in order to confirm consent to transactions, which may have the technical effect of reducing computing resources used by one or more devices within the system. Examples of such computing resources include, without limitation, processor cycles, network traffic, memory usage, storage space, and power consumption.

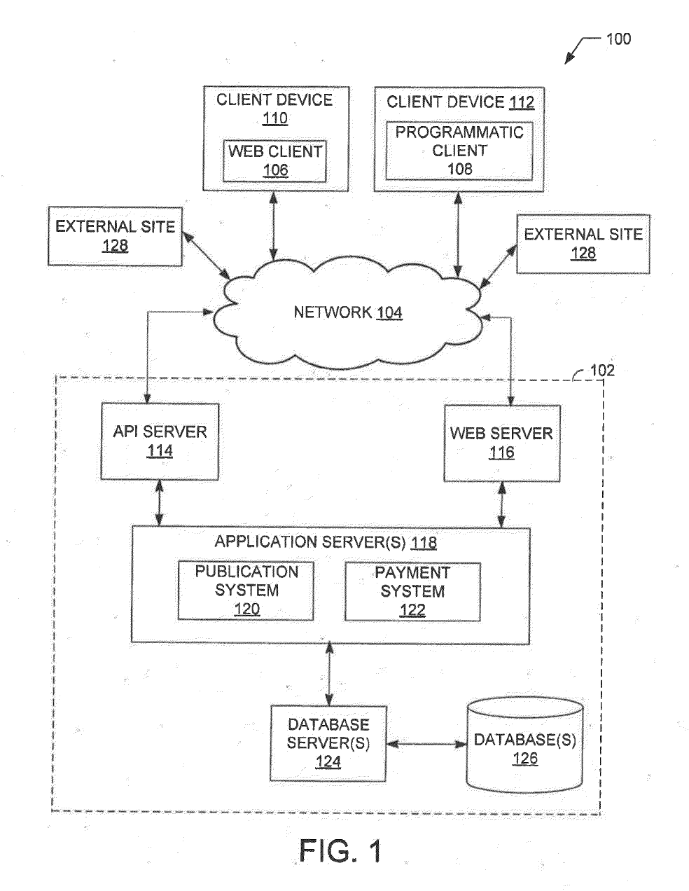

With reference to FIG. 1, an example embodiment of a high-level client-server-based network architecture 100 to enable the use of student accounts is shown. A networked system 102, in an example form of a network-server-side functionality, is coupled via a communication network 104 (e.g., the Internet, wireless network, cellular network, or as Wide Area Network (WAN)) to one or more client devices 110 and 112. FIG. 1 illustrates, for example, a web client 106 operating via a browser (e.g., such as the INTERNET EXPLORER® browser developed by Microsoft® Corporation of Redmond, Wash. State), and a programmatic client 108 executing on respective client devices 110 and 112.

The client devices 110 and 112 may comprise a mobile phone, desktop computer, laptop, or any other communication device that a user may utilize to access the networked system 102. In some embodiments, the client device 110 may comprise a display module (not shown) to display information (e.g., in the form of user interfaces). In further embodiments, the client device 110 may comprise one or more of a touch screen, accelerometer, camera, microphone, and GPS device. The client devices 110 and 112 may be a device of an individual user, such as a parent or a child, which is used to access information or perform transactions in the networked system 102. In one embodiment, the networked system 102 is a network-based marketplace that publishes publications comprising item listings of products for sale on the network-based marketplace and manages payments for these marketplace transactions.

An Application Program interface (API) server 114 and a web server 116 are coupled to, and provide programmatic and web interfaces respectively to, one or more application servers 118. The application servers 118 host a publication system 120 and a payment system 122, each of which may comprise one or more modules, applications, or engines, and each of which may be embodied as hardware, software, firmware, or any combination thereof. The application servers 118 are, in turn, coupled to one or more database servers 124 facilitating access to one or more information storage repositories or database(s) 126, in one embodiment, the databases 126 are storage devices that store information to be posted to the publication system 120. The databases 126 may also store account information for adults and minors in accordance with example embodiments.

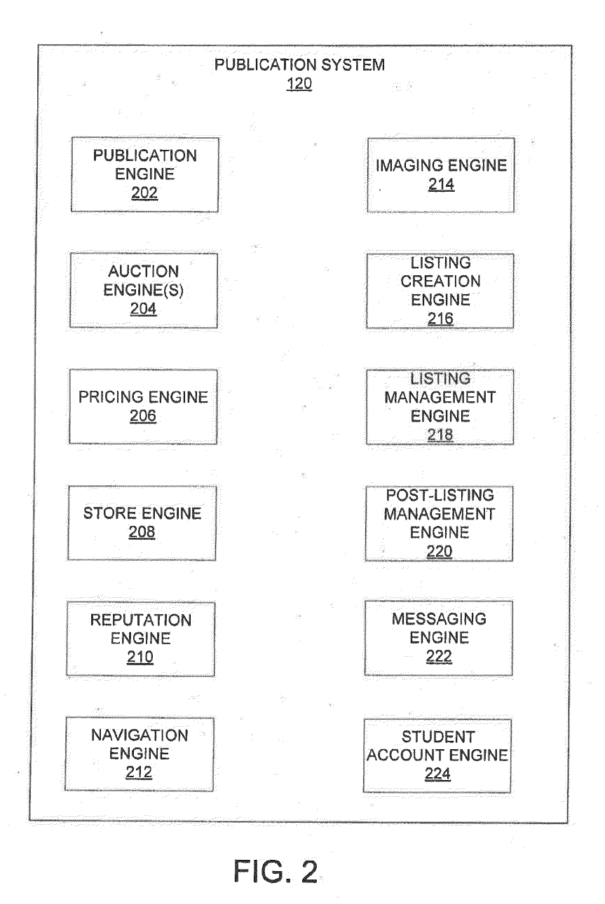

In example embodiments, the publication system 120 publishes content on a network (e.g., Internet). As such, the publication system 120 provides a number of publication and marketplace functions and services to users that access the networked system 102. The publication system 120 is discussed in more detail in connection with FIG. 2. In example embodiments, the publication system 120 is discussed in terms of a marketplace environment. However, it is noted that the publication system 120 may be associated with a non-marketplace environment such as an informational or social networking environment.

The payment system 122 provides a number of payment services and functions to users. The payment system 122 allows users to accumulate value (e.g., in a commercial currency, such as the U.S. dollar, or a proprietary currency, such as “points”) in their accounts, and then later to redeem the accumulated value for products (e.g., goods or services) that are made available via the publication system 120 or elsewhere on the network 104. The payment system 122 also facilitates payments from a payment mechanism (e.g., a bank account, PayPal™, or credit card) for purchases of items via any type and form of a network-based marketplace.

In example embodiments, the payment system 122 verifies each user establishing a payment account with the payment system 122. When a user creates the payment account, the user provides at least one funding source or payment mechanism that establishes or provides a credit history. Based on the funding source and other information provided by the user when creating the payment account (e.g., employment information, driver's license information), the user may be verified as being an adult (e.g., over the age of 18 or some other predetermined age). It is noted that in some embodiments, a separate account is established at each system which may be linked to each other for each user (e.g., a user account at the publication system 120 and a payment account at the payment system 122). Alternative embodiments may contemplate having a single account for both systems that includes payment functionalities.

The networked environment of FIG. 1 may be coupled to a plurality of external sites 128. These external sites 128 may include social network sites (e.g., Facebook, Link-in), marketplace sites (e.g., auction sites), shopping sites (e.g., Amazon), informational sites (e.g., library or school websites), or any other website available on the network 104. The users may access these sites and, for example, use their payment account established with the payment system 122 to pay for or receive funds from transactions taking place at these external sites 128. Furthermore, by leveraging the ability to verify adult status by the payment system 122, parental consent for minors to transact or establish accounts on these external sites 128 may be automatically provided as will be discussed further below.

While the publication system 120 and the payment system 122 are shown in FIG. 1 to both form part of the networked system 102, it will be appreciated that, in alternative embodiments, the payment system 122 may form part of a payment service that is separate and distinct from the networked system 102. Additionally, while the example network architecture 100 of FIG. 1 employs a client-server architecture, a skilled artisan will recognize that the present disclosure is not limited to such an architecture. The example network architecture 100 can equally well find application in, for example, a distributed or peer-to-peer architecture system. The publication system 120 and payment system 122 may also be implemented as standalone systems or standalone software programs operating under separate hardware platforms, which do not necessarily have networking capabilities.

Referring now to FIG. 2, an example block diagram illustrating multiple components that, in one embodiment, are provided within the publication system 120 of the networked system is shown. In this embodiment, the publication system 120 is a marketplace system where items (e.g., goods or services) may be offered for sale. The publication system 120 may be hosted on dedicated or shared server machines (not shown) that are communicatively coupled to enable communications between the server machines. The multiple components themselves are communicatively coupled (e.g., via appropriate interfaces), either directly or indirectly, to each other and to various data sources, to allow information to be passed between the components or to allow the components to share and access common data. Furthermore, the components may access the one or more databases 126 via the one or more database servers 124.

The publication system 120 provides a number of publishing, listing, and price-setting mechanisms whereby a seller may list for publish information concerning) goods or services for sale, a buyer can express interest in or indicate is desire to purchase such goods or services, and a price can be set for a transaction pertaining to the goods or services. To this end, the publication system 120 may comprise at least one publication engine 202 and one or more auction engines 204 that support auction-format listing and price setting mechanisms (e.g., English, Dutch, Chinese, Double, Reverse auctions, etc.).

A pricing engine 206 supports various price listing formats. One such format is a fixed-price listing format (e.g., the traditional classified advertisement-type listing or a catalog listing). Another format comprises a buyout-type listing. Buyout-type listings (e.g., the Buy-It-Now (BIN) technology developed by eBay Inc., of San Jose, Calif.) may be offered in conjunction with auction-format listings and allow a buyer to purchase goods or services, which are also being offered for sale via an auction, for a fixed price that is typically higher than a starting price of an auction for an item.

A store engine 208 allows a seller to group listings within a “virtual” store, which may be branded and otherwise personalized by and for the seller. Such a virtual store may also offer promotions, incentives, and features that are specific and personalized to the seller. In one example, the seller may offer a plurality of items as Buy-It-Now items in the virtual store, offer a plurality of items for auction, or a combination of both.

A reputation engine 210 allows users that transact, utilizing the networked system 102, to establish, build, and maintain reputations. These reputations may be made available and published to potential trading partners. Because the publication system 120 supports person-to-person trading between unknown entities, in accordance with one embodiment, users may otherwise have no history or other reference information whereby the trustworthiness and credibility of potential trading partners may be assessed. The reputation engine 210 allows a user, for example through feedback provided by one or more other transaction partners, to establish a reputation within the network-based marketplace over time. Other potential trading partners may then reference the reputation for purposes of assessing credibility and trustworthiness.

Navigation of the network-based marketplace may be facilitated by a navigation engine 212. For example, a search module (not shown) of the navigation engine 212 enables keyword searches of listings published via the publication system 120. In a further example, a browse module (not shown) of the navigation engine 212 allows users to browse various category, catalog, or inventory data structures according to which listings may be classified within the publication system 120. Various other navigation applications within the navigation engine 212 may be provided to supplement the searching and browsing applications.

In order to make listings available via the networked system 102 as visually informing and attractive as possible, the publication system 120 may include an imaging engine 214 that enables users to upload images for inclusion within listings and to incorporate images within viewed listings. The imaging engine 214 also receives image data from a user and utilizes the image data to identify an item depicted or described by the image data.

A listing creation engine 216 allows sellers to conveniently author listings of items. In one embodiment, the listings pertain to goods or services that a user (e.g., a seller) wishes to transact via the publication system 120. In other embodiments a user may create a listing that is an advertisement or other form of publication.

A listing management engine 218 allows sellers to manage such listings. Specifically, where a particular seller has authored or published a large number of listings, the management of such listings may present a challenge. The listing management engine 218 provides a number of features (e.g., auto-relisting, inventory level monitors, etc.) to assist the seller in managing such listings.

A post-listing management engine 220 also assists sellers with a number of activities that typically occur post-listing. For example, upon completion of an auction facilitated by the one or more auction engines 204, a seller may wish to leave feedback regarding a particular buyer. To this end, the post-listing management engine 220 provides an interface to the reputation engine 210 allowing the seller to conveniently provide feedback regarding multiple buyers to the reputation engine 210. Another post-listing action may be shipping of sold items whereby the post-listing management engine 220 may assist in printing shipping labels, estimating shipping costs, and suggesting shipping carriers.

A messaging engine 222 is responsible for the generation and delivery of messages to users of the networked system 102. Such messages include, for example, advising users regarding the status of listings and best offers (e.g., providing an acceptance notice to a buyer who made a best offer to a seller) or notifying parents of transaction performed by their minor. The messaging engine 222 may utilize any one of a number of message delivery networks and platforms to deliver messages to users. For example, the messaging engine 222 may deliver electronic mail (e-mail), an instant message (IM), a Short Message Service (SMS), text, facsimile, or voice (e.g., Voice over IP (VoIP)) messages via wired networks (e.g., the Internet), a Plain Old Telephone Service (POTS) network, or wireless networks (e.g., mobile, cellular, WiFi, WiMAX).

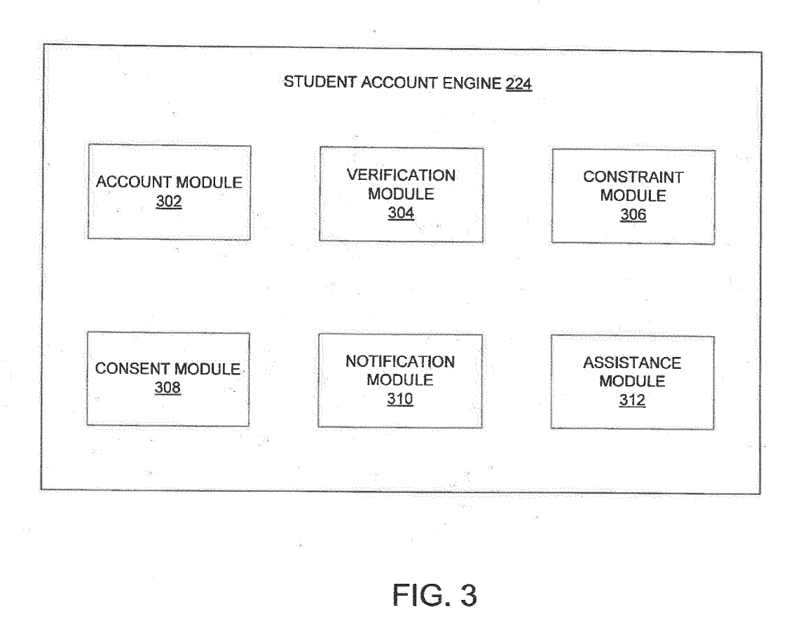

A student account engine 224 manages the establishment and monitoring of student accounts. Student accounts are accounts that may be established by a parent, guardian, or other adult for the benefit of a minor that the adult has a pre-existing relationship with (e.g., their child or grandchild). The student account engine 224 will be discussed in more detail in connection with FIG. 3 below.

Although the various components of the publication system 120 have been defined in terms of a variety of individual modules and engines, a skilled artisan will recognize that many of the items can be combined or organized in other ways. Furthermore, not all components of the marketplace system 120 have been included in FIG. 2. In general, components, protocols, structures, and techniques not directly related to functions of exemplary embodiments (e.g., dispute resolution engine, loyalty promotion engine, personalization engines, etc.) have not been shown or discussed in detail. The description given herein simply provides a variety of exemplary embodiments to aid the reader in an understanding of the systems and methods used herein.

FIG. 3 is a block diagram illustrating an example embodiment of the student account engine 224. The student account engine 224 manages student accounts in the networked system 102. An adult that has an account with the networked system 102 may establish a student account for a minor with whom the adult has a legal relationship. The student account engine 224 may comprise an account module 302, a verification module 304, a constraint module 306, a consent module 308, a notification module 310, and an assistance module 312.

The account module 302 allows the adult to establish a student account for their minor. In example embodiments, the account module 302 provides a user interface that includes a plurality of fields requesting information for establishing the student account. The information may include an e-mail address, user name, password, full name, and birthday of the minor. Other information such as schools, churches, family member, or other community groups may also be included. By collecting information regarding the community, the adult may indicate at a community level what network of individuals the minor is allowed to transact with (e.g., communicate with). For example, a school community (e.g., network of classmates and teachers), a church community, or a family community (e.g., immediate and local family members) may be established and constraints for transacting within these communities (e.g., allowing peer-to-peer transactions) may be provided.

Upon verification of the information, a student account may be established by the account module 302 for the minor. The account information may be stored to a database (e.g., database 126). It is noted that when the minor turns 18, based on the birthday provided by the adult, the student account may be automatically converted into a regular (adult) account. The reputation scores and other characteristics earned for the student account will transfer over to the regular account such that the minor-turned-adult will have a regular account that has a transaction history.

In one embodiment, the account module 302 allows a minor to contact, or “ping,” their parent to create an account for them. For example, the minor may access an interface provided by the account module 302. The minor will make a selection indicating a desire to obtain a student account and provide contact information for their parent or guardian. The account module 302 may then contact the adult and provide instructions for creating a student account.

The student account is an account that is for the sole use of the minor; however, the student account is linked to an adult account of the adult that created the student account. The student account will have essentially the same functionalities as an adult account, but transactions may be monitored or consent for completing transactions may be required from the adult of the linked adult account. For example, the minor may buy and sell on the publication system 120 and maintain a reputation score for their student account. However, the purchase or sale transactions involving the minor may be monitored or approved by the adult.

in one embodiment, the student account established at the publication system 120 may be linked to a secondary payment account of the payment system 122. The secondary payment account is a payment account established for a minor or other dependent that is financially linked to an adult payment account. Thus, the adult payment account is ultimately financially responsible for the secondary payment account. The minor may have funds in their secondary payment account that can be used to pay for transactions that occur in the publication system 120 or elsewhere in the network. Alternatively, the minor may deposit funds into their secondary payment account obtained from sale transactions on the network. It should be noted that in an alternative embodiment, the student account and the secondary payment account may be combined into a single account associated with the networked system 102.

The verification module 304 verifies the information provided by the adult and insures that an adult account is associated with the new student account. For example, the verification module 304 may verify that the adult creating the account has an adult account with the publication system 120 or the payment system 122. In some embodiments, the verification module 304 may also verify that the adult has a legal relationship with the minor. For example, the adult may need to agree to legal language that indicates that the information that they are providing is about an individual with whom the adult is a guardian of or has some form of legal relationship. In some embodiment, the verification module 304 may also insure that a corresponding secondary payment account is established or linked to the student account. However, if the student account is established without consent for the minor to perform monetary transactions, then the secondary payment account may not be necessary.

The constraint module 306 manages transaction constraints established by the adult for the student account. The constraint module 306 may receive various constraint settings from the adult to associate with the student account. Constraints cover types of actions that the minor may perform on the network as well as monitoring and approval requirements for the student account. Constraints may include, for example, types of merchants or categories of goods that the minor may view and transact, monetary limits for transactions, whether transactions are to be monitored by the adult, whether transactions are to be approved by the adult, or actions that the minor may perform on certain sites (e.g., add a connection or friend, information allowed to view). Constraints may vary based on the site (e.g., publication system 120 or external site 128) and may be individually established for each site. In some embodiments, information from rating boards may be linked to the student account to enable the adult to block these items (e.g., based on SKU numbers for items with age appropriate limits such as movies and music).

In example embodiments, default constraint settings may be provided to the adult. The adult may decide to accept the default settings or override them. The default settings may, in some embodiments, change based on experiences through the system. For instance, when the student account is first established, the initial constraints may require the adult to approve all transactions. As the minor completes successful transactions, the constraints may loosen. For example, the minor may, initially, be allowed to purchase on the publication system 120, but may not sell. After the minor has five successful purchase transactions, the minor may be allowed to sell on the publication system 120 with parental approval. After five successful sale transactions, the minor may then be allowed to sell with only parental monitoring (e.g., notification of the adult but not requiring any approval).

The consent module 308 manages consent settings for creation of accounts on external sites 128, in example embodiments, the adult may set up a list of external sites 128 for which the minor is granted permission to create accounts. By pre-establishing this list of external sites 128, the adult does not need to individually consent each time the minor attempts to create the account. For example, the minor may attempt to establish an account with a social network site, if the site is already on the pre-established consent list maintained by the consent module 308, verifiable parental/adult consent for the establishment of the social networking account may be automatically granted. The parental/adult consent is verifiable in that the publication system 120 has already established that the adult is an adult (e.g., based on the verified financial information of the payment account) and that the adult has a legal relationship with the minor (e.g., based on the verification obtained by the verification module 304).

The notification module 310 manages notifications and approval processing for transactions involving the student account. When a constraint, as determined by the constraint, module 306, requires notification to the adult or approval from the adult of a transaction performed by a minor, the notification module 310 provides the notification. The notification may be in the form of an e-mail, text message, phone call, or any other form of communication selected by the adult. In one embodiment, the notification may be presented on a publication account interface (e.g., a dashboard) whereon publication system information may be accessible by the adult.

The assistance module 312 provides assistance to the minor or adult with respect to the student account. For example, the assistance module 312 may provide tips via as personalized e-mail to the minor on how to improve their reputation score or how to improve future transactions. Similarly, the assistance module 312 may provide tips to the adult on how to help the minor with future transactions.

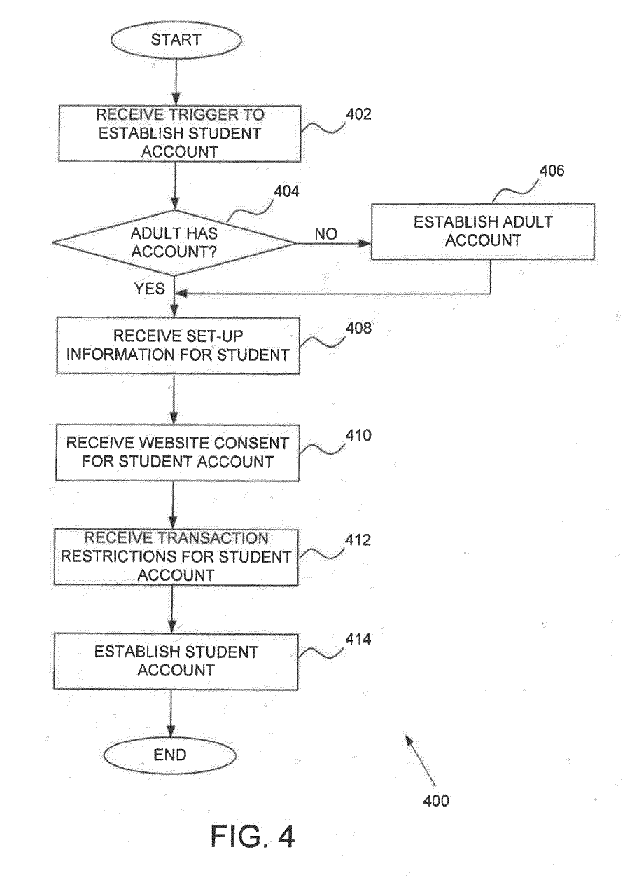

Referring now to FIG. 4, a flow diagram of an example high-level method 400 for establishing a student account is provided. In example embodiments, the adult will log into the networked system 102 in order to establish the student account. If the adult does not have an account already established at the networked system 102 (e.g., at the publication system 120 or the payment system 122), the adult may be required to establish an account for themselves first. While, some embodiments contemplate a publication system account and a separate payment system account for each adult, these accounts may be combined into a single account that is applicable to both systems.

In operation 402, a trigger is received by the account module 302 to establish the student account. In example embodiments, an adult will make a selection on an interface provided by the publication system 120 to create a student account. In an alternative embodiment, a minor may ping their parent or guardian to create the student account. In this embodiment, the account module 302 may send a communication to the adult in which the communication may contain a selectable link to trigger the student account set-up process.

In operation 404, a determination is made as to whether the adult has an account, in example embodiments, the verification module 304 may check that the adult has an account established with the networked system 102. For example, the verification module 304 may require the adult to log into their account or provide other verifying information to confirm that they have an account with the networked system 102. The verification module 304 also verifies that the account has been verified as an adult account. The verification of whether an account is an adult account may have been previously performed or is inherent based on verified financial information or credit history of the account (or associated payment account).

If the adult does not have an account previously established at the networked system 102, the adult may be required to establish an adult account in operation 406. The account module of the student account engine 224 or a separate account module of the networked system 102 may collect information from the adult, verify the information, and create the adult account.

Once the adult account is established, the information for the student may be received in operation 408. The account module 302 may provide a user interface that includes a plurality of fields requesting information for the student account. The information may include, for example, an e-mail address, user name, password, full name, and birthday of the minor.

In operation 410, consent for external websites is received from the adult via the interface. In example embodiments, the user interface provides a list of external sites 128 that utilize the networked system 102 to obtain adult consent for minor transactions on their sites. The adult may select one or more of the external sites 128 from this list to indicate with which external sites 128 the minor is allowed to create an account. For example, the minor may attempt to establish an account with an external shopping site. If the site is already on the pre-established consent list maintained by the consent module 308, verifiable adult consent for the establishment of the social networking account may be automatically granted for the minor to create the account. The adult consent is verifiable in that the publication system 120 has already established that the adult is an adult (e.g., based on the verified financial information of the payment account) and that the adult has a legal relationship with the minor (e.g., based on the verification obtained by the verification module 304).

While the adult may indicate consent when establishing the student account, alternatively or in addition, the adult may provide consent at a later time after the student account is established. For example, new external sites 128 may be added at a later time to the list of external sites 128 using the networked system 102 to obtain adult consent. The adult may simply access the list of available external sites 128 and select (or deselect) external sites to which consent is granted.

In operation 412, transaction constraints for the student account are received via the user interface. The constraints cover types of actions that the minor may perform on the network (e.g., at the networked system 102 or the external sites 128) as well as monitoring and approval requirements for the student account. The constraints may include, for example, types of merchants or categories of goods that the minor may view and transact, monetary limits for transactions, whether transactions are to be monitored by the adult, whether transactions are to be approved by the adult, or actions that the minor may perform on certain sites add a connection or friend, information allowed to view). Constraints may vary based on the site (e.g., publication system 120 or external site 128) and may be individually established for each site. Because each external site 128 may have different requirements and perform different transactions, the constraints may be customized for each external site 128.

in some embodiments, operations 410 and 412 may be combined into a single operation. For example, the adult may select the external websites 128 that consent is granted to and provide constraints for actions that the minor may perform at the external websites 128. It should be noted that in some embodiments, operation 410 may be optional. For example, the adult may just want to establish a student account for use in the networked system 102 without any consent for external sites 128.

Once all the information is received from the adult, the student account may be established in operation 414. It is noted that in some embodiments, the student account may be established upon receiving the set-up information in operation 408 and the consent and constraints are subsequently added to the student account as an update.

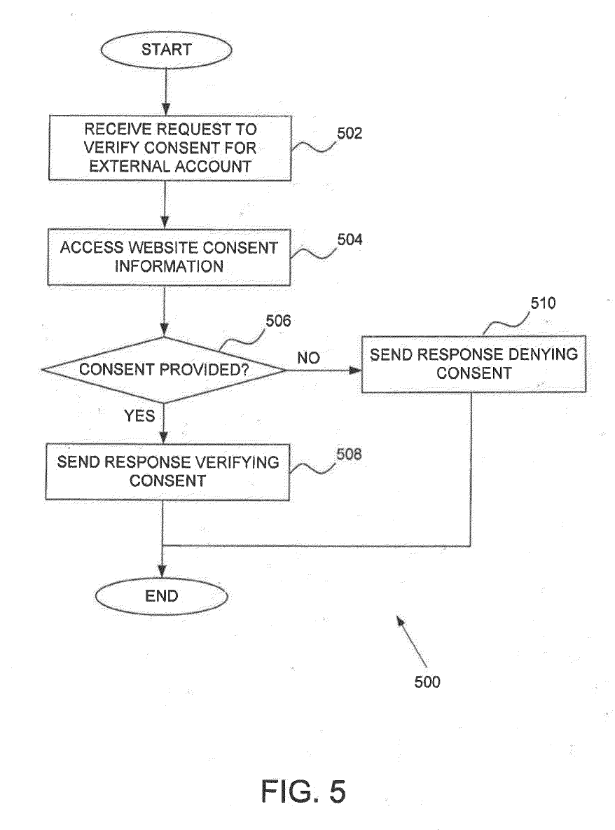

FIG. 5 is a flow diagram of an example high-level method 500 for verifying consent for creating an external account. External sites 128 may not have the ability or the resources to allow minors to create accounts or perform transactions wherein parental consent is required. The networked system 102 can provide a service whereby these external sites 128 may call up the networked system 102 and leverage the verified adult account information and defined relationships between the adult and a minor having a student account to verify based on the permission-based rights system whether the minor is allowed to perform actions on the external site 128.

The method 500 is triggered when a minor attempts to create an account at an associated external site 128. The external site 128 is associated by virtue of an agreement between the external site 128 and the networked system 102 that indicates a relationship whereby the networked system 102 is to provide parental/adult verification for transactions (including account establishment) at the external site 128. For illustration purposes, assume that the minor is attempting to establish an account with a social network site that has an agreement in place with the networked system 102.

The associated external site 128 (e.g., the social networking site) sends a request to the networked system 102 to obtain the parental consent. The request is received in operation 502 by the consent module 308 in operation 502. The request contains information identifying the minor, such as name, e-mail address, or username at the networked system 102.

Using the information received in the request, the consent module 308 accesses the website consent information stored for the identified student account. The consent information may be accessed from the database 126, in this example, the consent module 308 will access account information for the identified minor and review the corresponding consent information stored in the account for the social network site.

The consent information for the student account is reviewed by the consent module 308 to determine whether consent is granted by the adult for the establishment of the external site account in operation 506. If consent is granted, a response is sent in operation 508 by the consent module 308 verifying the consent. Alternatively, if there is no consent granted, a response is sent in operation 510 denying consent. In some embodiments, the adult may be notified of the verifying or denying of consent.

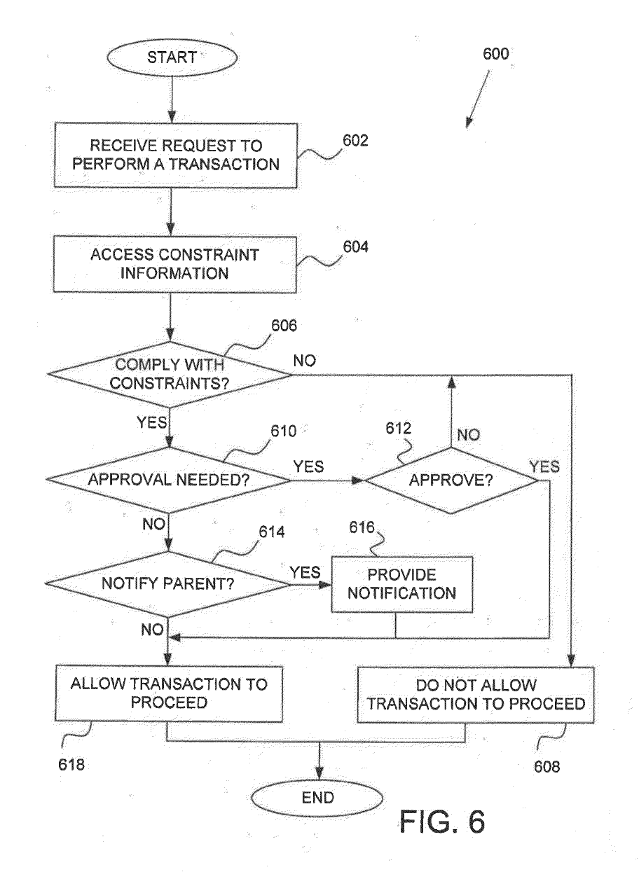

Subsequent transactions performed by the minor are checked against established constraints placed on the student account with respect to the external site 128, in some embodiments, the constraints may be provided by the constraint module 306 to the external site 128 once the consent is verified in operation 508) so that the external site 128 may independently enforce the constraints. In other embodiments, constraints for transactions performed on the external sites 128, as well as transactions performed in the networked system 102, may be checked by the constraint module 306 of the networked system 102. The process for checking constraints at the networked system 120 is discussed in FIG. 6.

FIG. 6 is a flow diagram of an example high-level method 600 for processing a transaction and checking constraints associated with the student account. Whenever a minor attempts to perform a transaction, the constraints for the transaction may be reviewed by the constraint module 306. For purposes of illustrations, assume in one example that the minor wants to purchase an item.

In operation 602, as request to perform a transaction is received by the constraint module 306, in the case where the transaction is at an external site 128, the request may indicate a transaction to be performed at the external site 128. Thus in the example, a request is received to purchase an item. The request may include information identifying the minor and the student account.

In operation 604, the constraint module 306 accesses constraints associated with the identified student account. The constraints may be accessed, for example, from the database 126 based on the identifier of the student account received in the request.

Binary constraints are then reviewed and a determination is made in operation 606 whether the transaction complies with constraints for the student account. These binary constraints allow for a determination of whether to approve or deny the transaction purely on the constraint conditions established for the student account. For example, a binary constraint may include an item, merchant, or category of goods that the minor is barred from purchasing or viewing, if the transaction does not comply with the binary constraints, then the transaction is not allowed to proceed in operation 608. In cases where the transaction is being performed at the external site 128, a response may be sent to the external site 128 indicating the non-compliance of the transaction with the constraints. For example, if the minor is attempting to purchase an item that costs $30 from an external site (e.g., Amazon) but a binary constraint established for this external site for the minor indicates that purchases over the amount of $25 are not allowed, then the external site is notified not to allow the transaction to proceed.

If the transaction complies with the binary constraints in operation 606 or if there are no binary constraints, then a determination is made in operation 610 as to whether adult approval is need. Continuing with the example, if the minor is attempting to purchase an item that costs $30 and the constraints for the shopping site or publication system 120 allows for purchases over $25 only with parental approval, then an approval notification may be sent to the adult. In operation 612, a determination is made as to whether the adult approves the transaction.

If no approval is needed, then a determination may be made as to whether notification of the adult is required in operation 614. Using the same example, if the minor is attempting to purchase an item that cost $30 and the constraints for the shopping site allows for purchases under $35 without parental approval, but requires parental notification, then the notification may be provided in operation 616. It's noted that the notification of the adult may trigger an action by the adult. For example, the minor may not have enough funds in their secondary payment account to pay for a purchase. Therefore, the adult may transfer funds to the minor's secondary payment account.

Notifications may, in one embodiment, be presented to the adult via a user interface (e.g., dashboard) associated with the adult account with the publication system 120. The user interface may present account information to the adult along with a section dedicated to notices for the linked student account. These notices may include, for example, approval/denial requests along with monitoring notices, listings to be reviewed (if the minor it attempting, to sell something on the publication system 120), communications to/from the minor and other members of the network.

Based on the receipt of an approval from operation 612 or constraints not requiring any approval, the transaction is allowed to proceed in operation 618. In the ease where the transaction is being performed at the external site 128, a response may be sent to the external site 128 indicating allowance for proceeding with the transaction.

While a purchasing scenario was discussed above, the method 600 equally applies to a selling scenario, in this example, the minor may generate a listing for the publication system 120 using the listing creation engine 216 which triggers a request to perform a transaction (operation 602). Assuming the minor has permission to sell (complies with binary constraints in operation 606), the adult may review, edit, and approve the listing (in operation 610 and 612). Alternatively, the adult may be notified of the listing (operation 614). The listing is then posted to the publication system 120. The adult may monitor all communications between the minor and buyer if the constraints require communication monitoring.

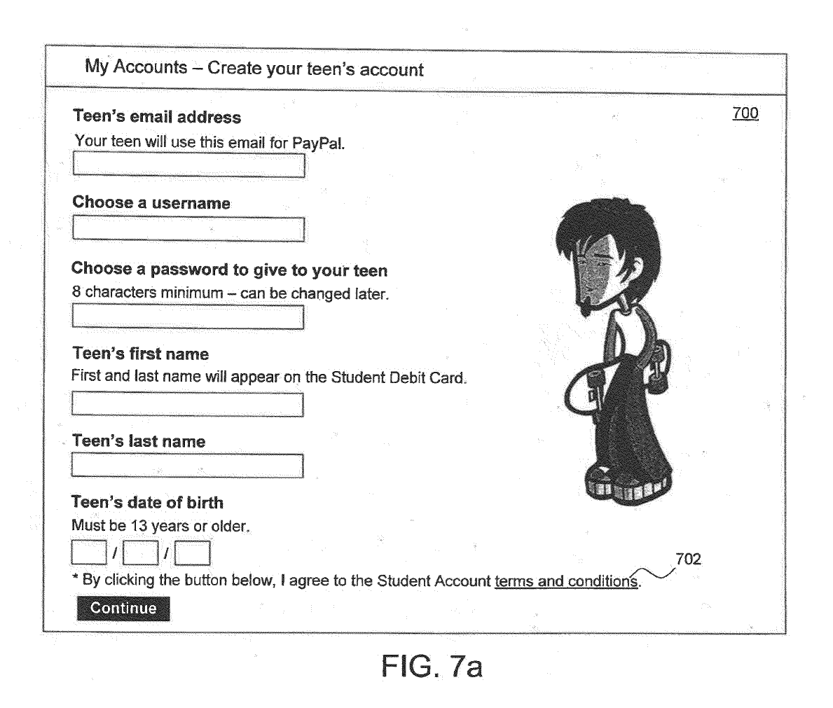

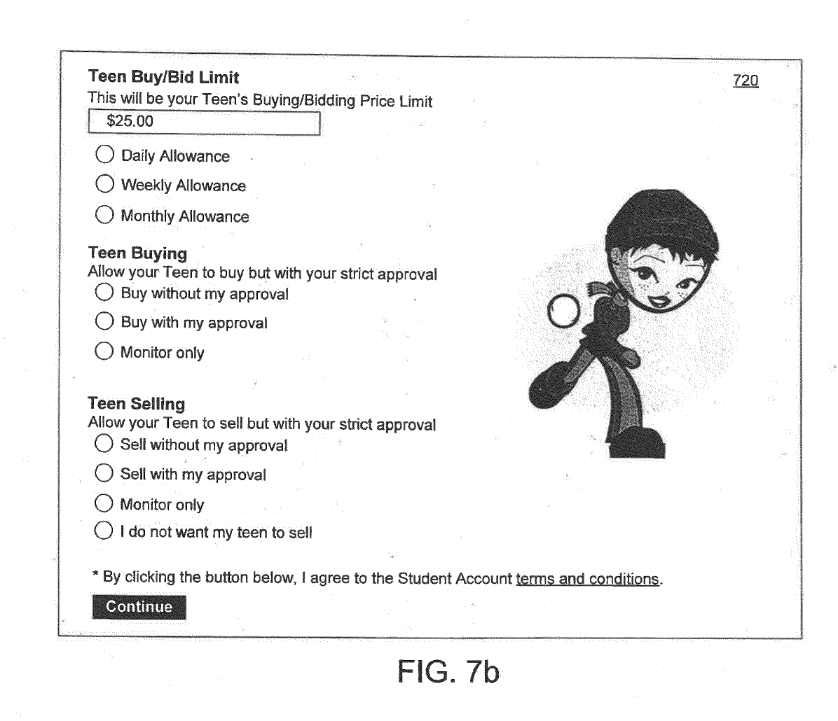

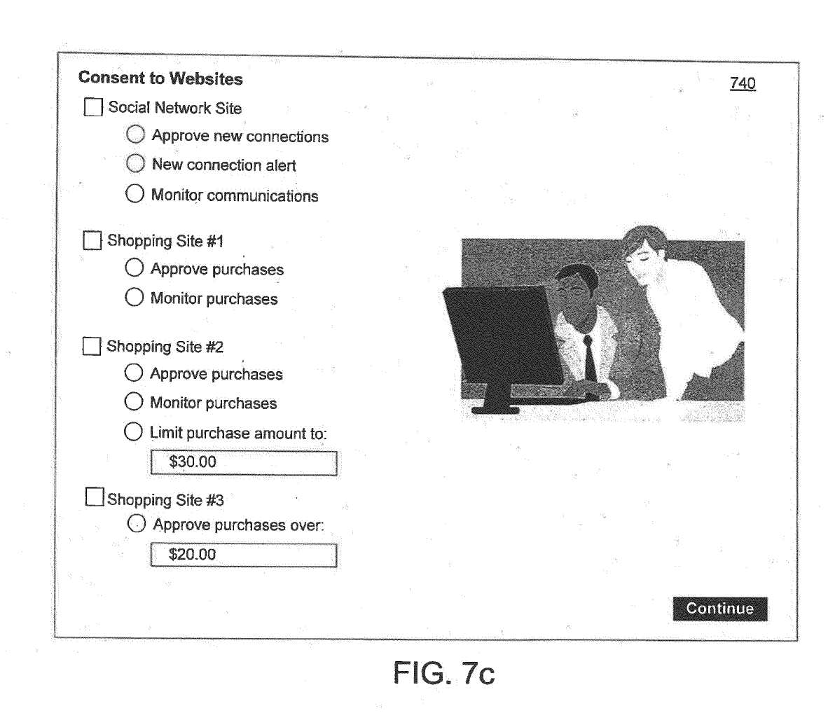

FIG. 7a is sample user interface 700 for creating a student account. The interface 700 is provided by the account module 302 to a parent or guardian upon receiving a trigger to establish the student account. The interface 700 provides fields for the adult to enter information to create the account including an e-mail address, a username, a password, the minor's full name, and date of birth. In one embodiment, the c-mail address may be used to contact the minor and also used to establish the corresponding secondary payment account, if one is needed. The username and password may be changed later by the minor. Alternative embodiments may request other information or less than all of the information requested on the interface 700.

A selection 702 for reviewing terms and conditions for establishing the student account is also provided on the interface 700. The terms and conditions may include legal language that indicates that the information the adult is providing is about an individual with whom the adult is a guardian of or has some legal relationship and the adult agrees to be held accountable for the minor's actions. The adult may be required to agree with these terms and conditions in order for the student account to be created.

FIG. 7b is a sample user interface 720 for establishing constraints for the student account for the publication system 120 of the networked system 102. The interface 720 allows the adult to set amount limits for buying or bidding on items and to indicate the applicability of the limit (e.g., daily, weekly, monthly). The interface 720 also allows the adult to indicate whether notification (e.g., monitoring) or approval for any purchases on the publication system 120 is required. The minor may also be allowed to sell items on the publication system 120. The adult may indicate whether the sale of items should be monitored (e.g., notification only), with approval by the adult, without any approval or monitoring, or not allowed to sell anything. Further constraints on actions that the minor can perform on the publication system 120 may be provided for the student account. As noted above, a default constraint setting may be provided in some embodiments and the adult may override the defaults.

FIG. 7e is a sample user interface 740 for establishing consent and constraints for external sites 128 for the student account. The adult may use the interface 740 tin set up a list of external sites 128 for which parental consent is given for the minor to engage in transactions (e.g., create accounts). External sites 128 that have an agreement with the networked system 102 for the networked system 102 to provide parental/adult consent for transactions (including account establishment) for the external site 128 are listed on the interface 740. The adult may then select the external sites 128 that the adult wants to grant consent for the minor to establish an account or to perform transactions.

In the example user interface 740, four external sites 128 are listed, although any number and types of external sites 128 may be provided. In this example, the adult may select from social network site, shopping site #1, shopping site #2, and shopping site #3. Should the adult select one or more of these external sites 128, the adult may provide constraints for the selected external site 128. The constraints for each external site 128 may be customized based on the external site 128, their requirements, and their transaction types. For the social network site, for example, the adult may be select one or more constraints directed to approving new connections (e.g., new friends), obtaining a new connection alert, or monitoring communications. Constraints for shopping site 41 include approving a purchase or monitoring purchases, while constraints for shopping site #2 include approving purchases, monitoring purchases, and setting a limit for a purchase amount. Shopping site #3 provides a constraint for approving purchases over a selectable amount. Any type or combination of constraints may be provided for an external site 128.

### Modules, Components, and Logic

Additionally, certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain example embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in dedicated and permanently configured circuitry, or in temporarily configured circuitry (e.g., configured by software) may be driven by, for example, cost, time, energy-usage, and package size considerations.

Accordingly, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

### Example Machine Architecture and Machine-Readable Medium

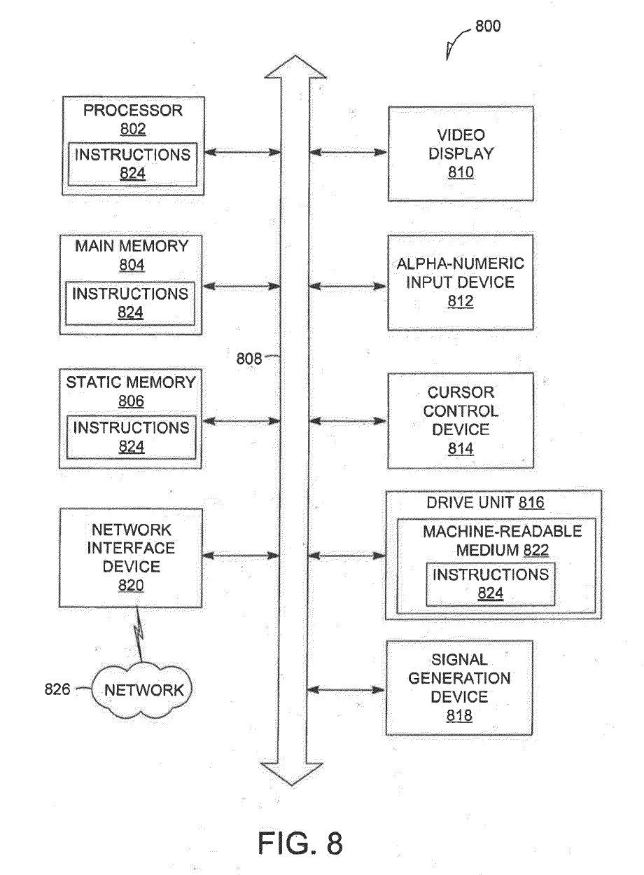

With reference to FIG. 8, an example embodiment extends to a machine in the example form of a computer system 800 within which instructions for causing the machine to perform any one or more of the methodologies discussed herein may be executed. In alternative example embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, a switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 may include a processor 802 (e.g., a central processing unit (CPU), a graphics processing unit (GPU) or both), a main memory 804 and a static memory 806, which communicate with each other via a bus 808. The computer system 800 may further include a video display unit 810 (e.g., a liquid crystal display (LCD) or a cathode ray tube (CRT)). In example embodiments, the computer system 800 also includes one or more of an alpha-numeric input device 812 (e.g., a keyboard), a user interlace (UI) navigation device or cursor control device 814 (e.g., a mouse), a disk drive unit 816, a signal generation device 818 (e.g., a speaker), and a network interface device 820.

### Machine-Readable Storage Medium

The disk drive unit 816 includes a machine-readable storage medium 842 on which is stored one or more sets of instructions 824 and data structures (e.g., software instructions) embodying or used by any one or more of the methodologies or functions described herein. The instructions 824 may also reside, completely or at least partially, within the main memory 804 or within the processor 802 during execution thereof by the computer system 800, with the main memory 804 and the processor 802 also constituting machine-readable media.

While the machine-readable storage medium 822 is shown in an example embodiment to be a single medium, the term “machine-readable storage medium” may include a single medium or multiple media (e.g., a centralized or distributed database, or associated caches and servers) that store the one or more instructions. The term “machine readable medium” shall also be taken to include any tangible medium that is capable of storing, encoding, or carrying instructions for execution by the machine and that cause the machine to perform any one or more of the methodologies of embodiments of the present invention, or that is capable of storing, encoding, or carrying data structures used by or associated with such instructions. The term “machine-readable storage medium” shall accordingly be taken to include, but not be limited to, solid-state memories and optical and magnetic media. Specific examples of machine-readable storage media include nom volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks,

### Transmission Medium

The instructions 824 may further be transmitted or received over a communications network 826 using a transmission medium via the network interface device 820 and utilizing any one of a number of well-known transfer protocols (e.g., HTTP). Examples of communication networks include a local area network (LAN), a wide area network (WAN), the Internet, mobile telephone networks, POTS networks, and wireless data networks (e.g., WiFi and WiMax networks). The term “transmission medium.” shall be taken to include any intangible medium that is capable of storing, encoding, or carrying instructions for execution by the machine, and includes digital analog communications signals or other intangible medium to facilitate communication of such software.

Although an overview of the inventive subject matter has been described with reference to specific example embodiments, various modifications and changes may be made to these embodiments without departing from the broader spirit and scope of embodiments of the present invention. Such embodiments of the inventive subject matter may be referred to herein, individually or collectively by, the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention, in general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

1. A machine-readable storage medium in communication with at least one processor of a machine, the machine-readable storage medium storing instructions which, when executed by the at least one processor of the machine, cause the machine to perform operations comprising:
receiving instructions to establish an account for a minor from a verified adult that is verified as an adult based on financial information associated with an adult account established for the verified adult;
creating the account for the minor that is inked to the adult account of the verified adult; and
establishing a secondary payment account for the minor that is linked to the account of the minor, the secondary payment account being a payment account established for the minor that is financially linked to an adult payment account associated with the adult account of the verified adult.

2. The machine-readable storage medium of claim 1, wherein the operations further comprise verifying a legal relationship between the verified adult and the minor, the creating of the account for the minor being based on the verifying.

3. The machine-readable storage medium of claim 1, wherein the operations further comprise receiving constraint settings for the account of the minor from the verified adult that indicate constraints on transactions the minor attempts to perform.

4. The machine-readable storage medium of claim 3, wherein the constraints are at least one selection from the group consisting of approving transactions, monitoring transactions, setting monetary limits, restricting categories, restricting items, and restricting merchants.

5. The machine-readable storage medium of claim 1, wherein the verified adult is verified based on confirmed financial information for the adult payment account linked to the adult account, the confirmed financial information including at least one selection from the group consisting of a bank account, credit history, credit card account, and employment information.

6. The machine-readable storage medium of claim 1, wherein the adult account is the adult payment account and wherein the verified adult is verified based on confirmed financial information in the adult account.

7. The machine-readable storage medium of claim 1, wherein the operations further comprise applying constraints to the account of the minor that loosen based on time and successful completion of transactions by the minor.

8. The machine-readable storage medium of claim 1, wherein the operations further comprise:
receiving a request for the minor to perform a transaction;
accessing constraint settings established by the verified adult for the account of the minor;
determining whether the transaction complies with the constraint settings; and
allowing the transaction to proceed based on the transaction complying with the constraint settings.

9. The machine-readable storage medium of claim 1, wherein the adult payment account is ultimately financially responsible for the secondary payment account.

10. The machine-readable storage medium of claim 1, wherein the account of the minor and the secondary payment account comprise a single account associated with the minor.

11. A method comprising:
receiving instructions to establish an account for a minor from a verified adult that is verified as an adult based on financial information associated with an adult account established for the verified adult;
creating the account for the minor that is linked to the adult account of the verified adult; and
establishing, using a processor of a machine, a secondary payment account for the minor that is linked to the account of the minor, the secondary payment account being a payment account established for the minor that is financially linked to an adult payment account associated with the adult account of the verified adult.

12. The method of claim 11, further comprising verifying a legal relationship between the verified adult and the minor, the creating of the account for the minor being based on the verifying.

13. The method of claim 11, further comprising receiving constraint settings for the account of the minor from the verified adult that indicate constraints on transactions the minor attempts to perform.

14. The method of claim 13, wherein the constraints are at least one selection from the group consisting of approving transactions, monitoring transactions, setting monetary limits, restricting categories, restricting items, and restricting merchants.

15. The method of claim 11, wherein the verified adult is verified based on confirmed financial information for the adult payment account linked to the adult account, the confirmed financial information including at least one selection from the group consisting of a hank account, credit history, credit card account, and employment information.

16. The method of claim 11, wherein the adult account is the adult payment account and wherein the verified adult is verified based on confirmed financial information in the adult account.

17. The method of claim 11, further comprising applying constraints to the account of the minor that loosen based on time and successful completion of transactions by the minor.

18. The method of claim 11, further comprising:
receiving a request for the minor to perform a transaction;
accessing constraint settings established by the verified adult for the account of the minor;
determining whether the transaction complies with the constraint settings; and
allowing the transaction to proceed based on the transaction complying with the constraint settings.

19. The method of claim 11, wherein the account of the minor and the secondary payment account comprise a single account associated with the minor.

20. A system comprising:
a processor of a machine;
an account module to receive instructions to establish an account for a minor from a verified adult that is verified as an adult based on financial information associated with an adult account established for the verified adult and to create the account for the minor that is linked to the adult account of the verified adult; and
a verification module to insure, using the processor, that a secondary payment account established for the minor is linked to the account of the minor, the secondary payment account being a payment account established for the minor that is financially linked to an adult payment account associated with the adult account of the verified adult.
